(19) United States
(12) Patent Application Publication
(10) Pub. No.: US 2026/0335056 A1
(43) Pub. Date: Oct. 29, 2026

(54) BLANK FOR MANUFACTURING DENTAL PROSTHESIS

(71) Applicant: HASS CO., LTD., Gangneung-si, Gangwon-do (KR)

(72) Inventors: Hyung Bong LIM, Ansan-si, Gyeonggi-do (KR); Joon Hyung KIM, Anseong-si, Gyeonggi-do (KR); Hwan Soon KOH, Anyang-si, Gyeonggi-do (KR); Jin Woo OH, Gwangmyeong-si, Gyeonggi-do (KR)

(21) Appl. No.: 18/878,907

(22) PCT Filed: Jun. 21, 2023
(86) PCT No.: PCT/KR2023/008581

§ 371 Date: Dec. 26, 2024

(30) Foreign Application Priority Data
Jun. 29, 2022 (KR) 10-2022-0079838

(51) Int. Cl. A61C 13/00

(52) U.S. Cl. CPC A61C 13/0022

(57) ABSTRACT

The present invention comprises: a material part which provides a predetermined machining area that comes in direct contact with a machining tool of a machining apparatus, and which forms a plurality of side surfaces; loading grooves formed on the side surfaces of the material part; and guard parts which are mounted on the side surfaces of the material part by using the loading grooves, and which come into direct contact with a circular frame-shaped jig of the machining apparatus.

### TECHNICAL FIELD

The present disclosure relates to a blank used to manufacture a dental prosthesis and, more particularly, to a blank for manufacturing dental prostheses designed to tightly adhere to a jig of a machining apparatus to maintain processing precision while preventing cracks or damage from tool stress, vibration, or impact generated during a milling process.

### BACKGROUND ART

When a tooth is lost due to fractures, damage by dental caries (tooth decay), defects, etc., dental restorative or prosthetic procedures are performed. Dental prosthetic procedures refer to any procedure involving the removal of part or all of a tooth and creation and fitting of an artificial tooth that mimics a natural tooth.

A dental prosthesis can be produced using an automated CAD/CAM machining apparatus by designing a desired tooth on the screen through a CAD design process on the basis of the result of copying the shapes of a patient's teeth, gums, and other oral tissues in an impression and pouring plaster into the impression to produce a dental cast, or obtaining dentition and surrounding structures of the oral cavity through an intraoral scanning process.

A blank used to manufacture dental prostheses is pressed by a machining tool (bit) that moves while rotating at high speed, and thus it is important that the blank is firmly seated in a jig of a machining apparatus. If the blank shaken or moved by the force generated by the machining tool, the blank cannot be processed into a prosthesis of the set shape.

Because conventional blanks, especially large-area blanks designed to produce multiple prosthetics from a single blank, have a circular or oval shape when viewed from the top, they are placed in surface contact with jigs of machining apparatuses. That is, a conventional blank has a configuration in which the entire top edge thereof is in surface contact with the bottom surface of an upper jig made of a circular frame, and the entire bottom edge is in surface contact with the top surface of a lower jig made of a circular frame.

As above, since a conventional blank has a configuration in which the entire top and bottom edges thereof are in surface contact with jigs having a circular frame, the blank may be placed in position without moving from the high-speed rotational force or vertical machining pressure generated by a machining tool.

However, since a conventional blank has a configuration in which the entire top edge and the entire bottom edge thereof are in direct surface contact with an upper jig and a lower jig, respectively, there is a problem that the area processed by a machining tool is reduced, and in particular, cracks may occur due to the instantaneous rotational force and pressing force of the machining tool, which can lead to serious damage.

Meanwhile, in the case of large-area blanks, since multiple prosthetics are manufactured intermittently or sequentially from a single blank depending on when a prosthesis is needed, repetitive clamping on a machining apparatus is inevitable, and such repeated clamping may cause the blank to fracture.

Accordingly, in order to solve the above problems, the present applicant proposed the present disclosure, and the related art documents include Korean Patent No. 10-1997032 titled “PROCESSING TABLE ASSEMBLY FOR PROCESSING DENTAL RESTORATIONS AND METHOD OF PROCESSING DENTAL RESTORATIONS USING THE SAME”.

### DISCLOSURE

### Technical Problem

The present disclosure is intended to solve the above problems occurring in the related art. An objective of the present disclosure is to provide a blank for manufacturing dental prostheses designed to prevent movement due to external force even when the processing area of a material part that is in direct contact with a machining tool is not in contact with a jig of a machining apparatus.

An objective of the present disclosure is to provide a blank for manufacturing dental prostheses that minimizes dead space by manufacturing a material part that is in direct contact with a machining tool in a polygonal shape, and that is designed to increase production efficiency of dental prosthetics.

An objective of the present disclosure is to provide a blank for manufacturing dental prostheses that prevents fracture even when exposed to repeated clamping on a machining apparatus during the milling process for prosthetic products.

### Technical Solution

In order to achieve the above mentioned objectives, there is provided a blank for manufacturing dental prostheses, the blank including: a material part configured to provide a predetermined processing area that is in direct contact with a machining tool of a machining apparatus, and to form a plurality of side surfaces; a seating groove provided on the plurality of side surfaces of the material part; and a guard part mounted on the plurality of side surfaces of the material part by using the seating groove, and configured to come into direct contact with a circular frame-shaped jig of the machining apparatus.

In addition, the seating groove may be provided on all of the side surfaces formed by the material part, or may be provided on some of the side surfaces formed by the material part.

In addition, the guard part may be provided in plural numbers on the material part at predetermined intervals along a circumferential direction of the material part.

In addition, a separation space may be created between the side surface of the material part and the jig.

In addition, the guard part may include: an inner member inserted into the seating groove with a shape corresponding to an inner space created by the seating groove; and an outer member integrally connected to the inner member and disposed to protrude outward from the side surface of the material part so as to make surface contact with the jig of the machining apparatus.

In addition, the seating groove, the side surface of the material part where the seating groove is provided and the guard part is mounted, and the guard part may have a curvature corresponding to a curvature of the circular frame-shaped jig.

In addition, the outer member may include: a first contact surface configured to extend upward or downward from a side of the inner member and to come in surface contact with the side surface of the material part; and a second contact surface configured to extend horizontally from a top or bottom of the first contact surface and to come in surface contact with a bottom or top surface of the circular frame-shaped jig.

In addition, the guard part may have a thickness smaller than a thickness of the material part.

In addition, when the circular frame-shaped jig is placed on the second contact surface, an inner peripheral surface of the jig may come in surface contact with the side surface of the material part that is not in contact with the first contact surface.

### Advantageous Effects

According to a blank for manufacturing dental prostheses of the present disclosure, since a guard part is provided that allows a material part to be stably fixed on a jig even when the processing area (top surface) of the material part is not in contact with the jig of a machining apparatus, the entire processing area of the material part can be utilized by preventing the processing range of a machining tool from interfering with the jig, and the production efficiency of dental prosthetics can be increased by minimizing the dead space of the material part.

Furthermore, according to a blank for manufacturing dental prostheses of the present disclosure, since the guard part is installed by being inserted into a seating groove formed on the side of the material part, the contact area between the material part and the guard part can be increased to further prevent the guard part from being separated due to external force.

Furthermore, according to a blank for manufacturing dental prostheses of the present disclosure, when the machining tool first contacts the processing area of the material part, the instantaneous stress generated at the contact area is dispersed to the outside, damage or cracking of the material part due to pressure generated from the machining tool or the jig can be prevented in advance.

Furthermore, according to a blank for manufacturing dental prostheses of the present disclosure, by providing the guard part, the processing process for a prosthesis can be repeatedly performed by clamping the relevant area, thereby preventing fracture due to repeated clamping.

### DESCRIPTION OF DRAWINGS

FIG. 1 is a perspective view of a blank according to an embodiment of the present disclosure.

FIG. 2 is a plan view of the blank shown in FIG. 1.

FIG. 3 is a side view of the blank shown in FIG. 1.

FIG. 4 is a perspective view showing a state in which a guard part is separated from a material part of the blank shown in FIG. 1.

FIG. 5 is a plan view of the material part according to an embodiment of the present disclosure.

FIG. 6 is a perspective view of the guard part according to an embodiment of the present disclosure.

FIG. 7 is a side view showing a jig in the form of a circular frame mounted on the guard part of the blank according to an embodiment of the present disclosure.

FIG. 8 is a perspective view of a blank according to another embodiment of the present disclosure.

FIG. 9 is a side view of the blank shown in FIG. 8.

FIG. 10 is a perspective view showing a state in which a guard part is separated from a material part of the blank according to another embodiment of the present disclosure.

FIG. 11 is a plan view of the material part according to another embodiment of the present disclosure.

### MODE FOR INVENTION

The advantages and features of the present disclosure and methods for achieving them will become clear by referring to the embodiments described in detail below in conjunction with the accompanying drawings.

However, the present disclosure is not limited to the embodiments disclosed below and may be implemented in various different forms. The embodiments are provided solely to ensure that the disclosure of the present disclosure is complete and to fully inform those skilled in the art of the scope of the present disclosure to which the present disclosure pertains. The present disclosure is defined only by the scope of the claims.

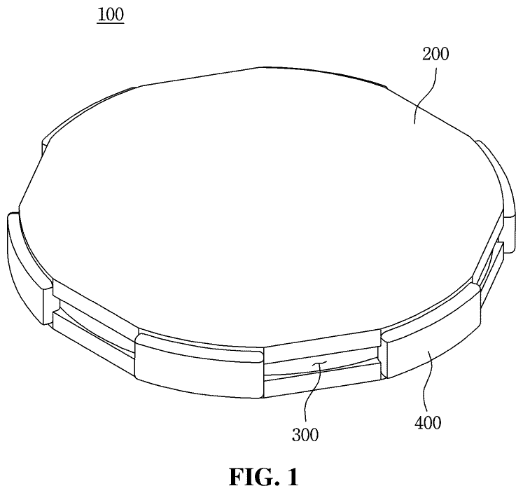

Hereinafter, a blank for manufacturing dental prostheses according to an embodiment of the present disclosure will be described in detail with reference to FIGS. 1 to 11. In describing the present disclosure, detailed descriptions of related well-known functions or configurations are omitted in order to not obscure the gist of the present disclosure.

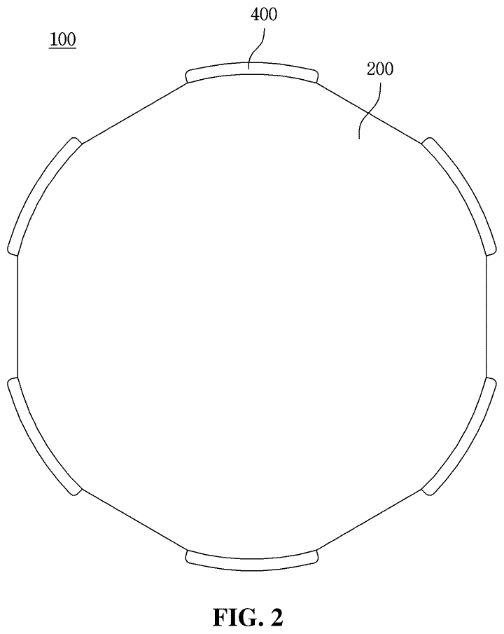

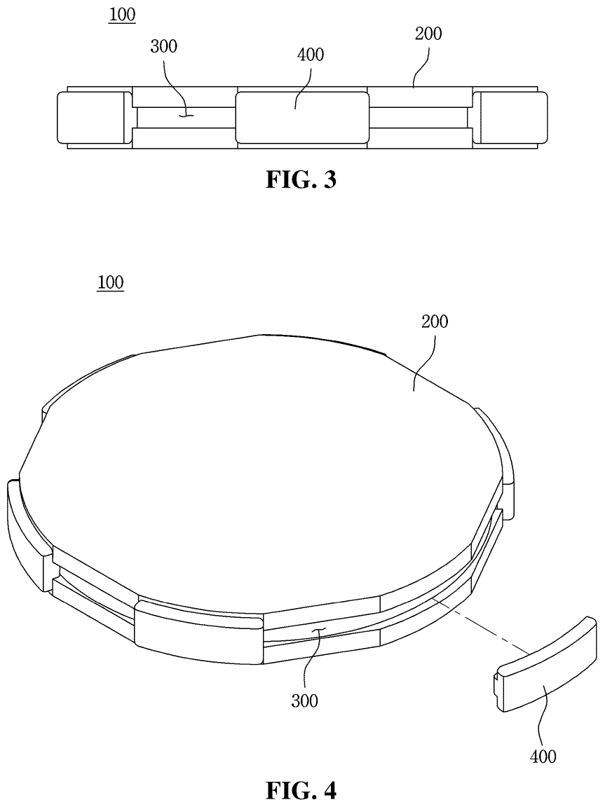

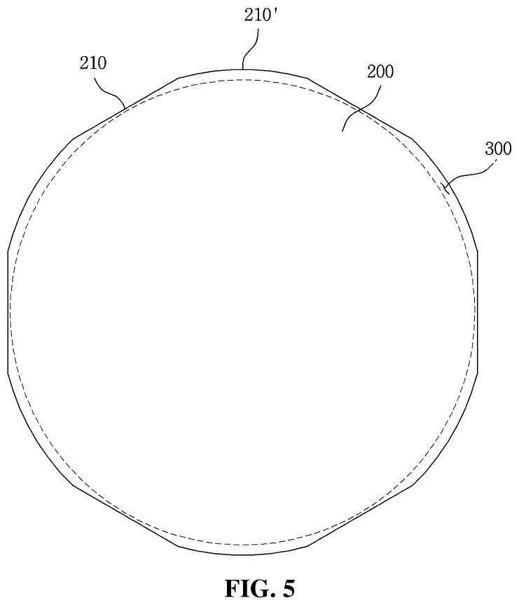

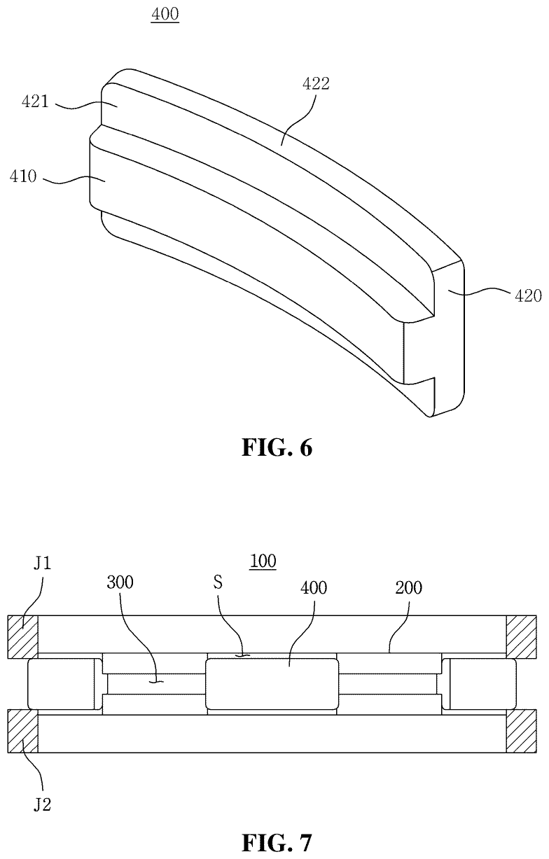

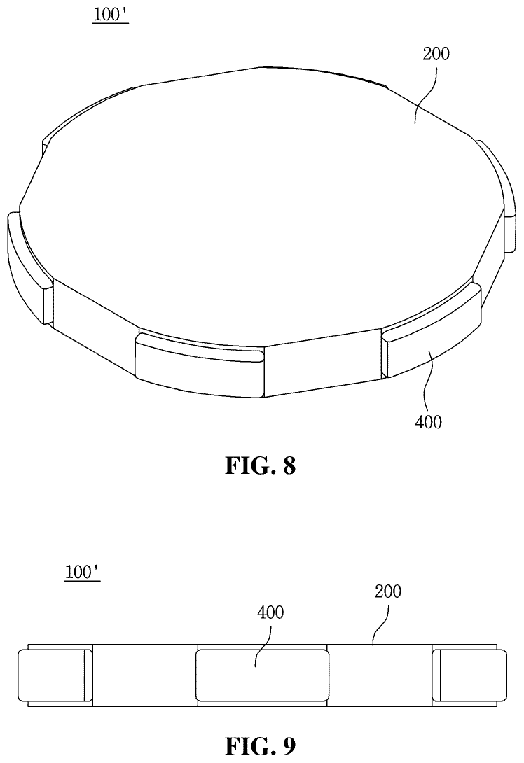

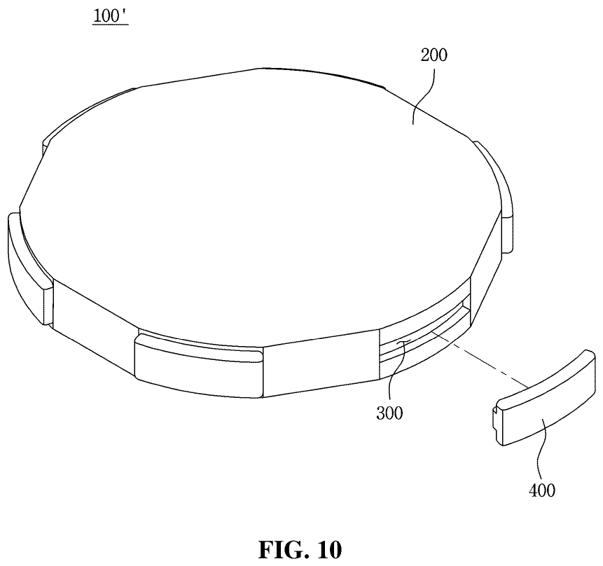

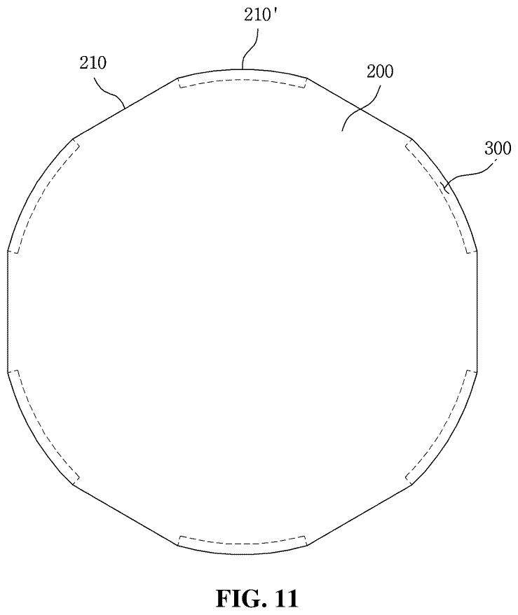

FIG. 1 is a perspective view of a blank according to an embodiment of the present disclosure; FIG. 2 is a plan view of the blank shown in FIG. 1; FIG. 3 is a side view of the blank shown in FIG. 1; FIG. 4 is a perspective view showing a state in which a guard part is separated from a material part of the blank shown in FIG. 1; FIG. 5 is a plan view of the material part according to an embodiment of the present disclosure; FIG. 6 is a perspective view of the guard part according to an embodiment of the present disclosure; FIG. 7 is a side view showing a jig in the form of a circular frame mounted on the guard part of the blank according to an embodiment of the present disclosure; FIG. 8 is a perspective view of a blank according to another embodiment of the present disclosure; FIG. 9 is a side view of the blank shown in FIG. 8; FIG. 10 is a perspective view showing a state in which a guard part is separated from a material part of the blank according to another embodiment of the present disclosure; and FIG. 11 is a plan view of the material part according to another embodiment of the present disclosure.

A blank for manufacturing dental prostheses according to the present disclosure is characterized by being constructed to prevent a material part from shaking or moving due to external force even when the material part used to manufacture a prosthesis is not in contact with a jig of a machining apparatus and to prevent cracks from occurring in the material part due to high-speed rotational force or vertical pressure generated from a machining tool.

As shown in FIGS. 1 to 3, a blank for manufacturing dental prostheses 100 may include a material part 200, a seating groove 300, and a guard part 400.

First, the material part 200 may be mounted on a jig (J1, J2, see FIG. 7) in the form of a circular frame constituting an artificial tooth machining apparatus.

The machining apparatus may be driven, for example, based on CAD (computer-aided design)/CAM (computer-aided manufacturing) data, and may process the material part 200 using a machining tool and by methods such as grinding, milling, or cutting.

The material part 200 provides a predetermined processing area that is in direct contact with the machining tool of the machining apparatus.

For reference, the material part 200 may be made of one or more of the following: glass or glass-ceramic, glass, composite resin or hybrid material, unsintered or a partially sintered or a densely-sintered ceramic, metal, or metal alloy. In addition, the material part 200 has characteristics such as high strength, thermal stability, and high corrosion resistance, and may be used alone in white or colored, or in a mixture of white and colored.

In addition, as shown in FIG. 5, the material part 200 may have a polygonal shape with multiple side surfaces 210 when viewed from the top.

As an example, the material part 200 may be manufactured in a polygon such as a hexagon, octagon, dodecagon, or hexagon. In an embodiment of the present disclosure, the material part 200 is shown in the description and drawings as having a substantially hexagonal planar shape, and accordingly, substantially six sides (in the description above and below, the surface of the blank including this “side” is defined as “side surface” 210.) are formed around the material part 200. In addition, among the six side surfaces 210, the vertex portion where two side surfaces 210 meet each other may be rounded to have a curvature corresponding to the curvature of jigs J1 and J2 having a circular frame shape. In other words, as shown in FIG. 5, the vertex portion of the material part 200 having a hexagonal planar shape may be rounded to have a curvature corresponding to the curvature of the jigs J1 and J2 to form a side surface 210′ having a curved shape. This side surface 210′ may be the vertex portion of the material part 200, which initially has a hexagonal planar shape.

The guard part 400, which will be described later, may be mounted on the side surface 210′ of the material part 200, which is rounded and has a curved shape. In an embodiment of the present disclosure, the drawings show that a plurality of side surfaces 210′ of the material part 200 having a curved shape are provided at regular intervals along the circumferential direction of the material part 200.

As shown in FIGS. 1 to 5, the seating groove 300 may be provided on all of the side surfaces 210 formed by the material part 200.

That is, the seating groove 300 is formed along the circumferential direction of the material part 200, and may have a circular curvature when viewed from the top as shown in FIG. 5.

The seating groove 300 having the above configuration provides a space into which an inner member 410 of the guard part 400, which will be described later, may be inserted.

The guard part 400 is a component that is in direct contact with the jigs J1 and J2 having a circular frame shape, and serves to prevent the material part 200 from moving due to external force while the material part 200 is processed by the machining tool.

The guard part 400 serves to protect the material part 200 from stress, impact, etc. transmitted from the machining apparatus or the machining tool, and in particular, is in direct contact with the jigs J1 and J2 having a circular frame shape and serves to support the material part 200 on the jigs J1 and J2. In addition, the guard part 400 may be made of a material different from that of the material part 200. For example, the guard part 400 may be made of plastic or metal.

In addition, the guard part 400 may be provided in plural numbers on the material part 200 at predetermined intervals along the circumferential direction of the material part 200.

Meanwhile, as shown in FIG. 6, the guard part 400 may include an inner member 410 and an outer member 420.

The inner member 410 is a component inserted into the seating groove 410 formed in the material part 200.

That is, the inner member 410 may be inserted into the seating groove 300 while having a shape corresponding to that of the seating groove 300 provided on the side surface 210′ having a curved shape among the plurality of side surfaces 210 formed by the material part 200. At this time, the inner member 410 may be formed to have a curvature corresponding to the curvature of the seating groove 300 or the curvature of the side surface 210′ having the curved shape.

The outer member 420 may be said to be a component that is in direct contact with the jigs J1 and J2 of the machining apparatus, and may be exposed to the outside by protruding outward from the side surface 210 of the material part 200 while being integrally connected to the inner member 410.

As an example, as shown in FIG. 7, the outer member 420 may be in surface contact with the bottom or top surface of the jigs J1 and J2 having a circular frame shape. At this time, the outer member 420 may be formed to have a curvature corresponding to the curvature of the seating groove 300.

Meanwhile, as shown in FIG. 6, the outer member 420 may include a first contact surface 421 and a second contact surface 422.

*The first contact surface 421 extends upward or downward from one side of the inner member 410 and may be in surface contact with the side surface 210 of the material part 200.

The second contact surface 422 extends horizontally from the top or bottom of the first contact surface 421 and may be in surface contact with the bottom or top surface of the jigs J1 and J2 having a circular frame shape.

Meanwhile, the guard part 400 has a thickness smaller than the thickness of the material part 200. That is, as shown in FIGS. 3 and 7, the height of the outer member 420 constituting the guard part 400 may be smaller than the thickness of the material part 200.

Accordingly, when the jigs J1 and J2 having a circular frame shape are seated on the second contact surface 422, the inner peripheral surfaces of the jigs J1 and J2 may be in surface contact with the side surface of the material part 200.

To be specific, the inner peripheral surfaces of the jigs J1 and J2 may be in surface contact with the side surface 210 of the material part 200 exposed in a space S shown in FIG. 7, and the side surface 210 of the material part 200 may be a surface portion that is not in contact with the first contact surface 421.

Since the outer member 420 of the guard part 400 constituting the blank 100 is in surface contact with the bottom or top surfaces of the jigs J1 and J2, and the side surface 210 of the material part 200 is configured to make surface contact with the inner peripheral surfaces of the jigs J1 and J2, the movement of the material portion 200 due to external force may be suppressed.

In addition, because the processing area (top surface) of the material part 200 has a configuration that does not contact the jigs J1 and J2, waste of the material part 200 may be reduced by fully utilizing the processing area (top surface) of the material part 200 for manufacturing dental prostheses.

In addition, because the material part 200 has a polygonal shape forming multiple side surfaces 210, separation space is created between the side surface of the material part 210 and the inner peripheral surface of the jigs J1 and J2 when viewed from the top. Accordingly, when the machining tool first contacts the processing area of the material part 200, the instantaneous stress generated at the contact area may be distributed to the outside through the space, and thus cracks in the material part 200 may be prevented.

For reference, the guard part 400 may be fixedly mounted on the side surface 210′ of the material part 200 using a known bonding material, or may be mounted on the side surface 210′ of the material part 200 using a fastening means such as a screw.

Hereinafter, a blank 100′ according to another embodiment of the present disclosure will be described with reference to FIGS. 8 to 11.

When compared to the blank 100 according to an embodiment of the present disclosure, the blank 100′ according to another embodiment of the present disclosure may be said to be different only in the formation position of the seating groove 300 provided on the side surface of the material part 200.

The seating groove 300 according to another embodiment of the present disclosure may not be provided on all of the plurality of side surfaces 210 formed by the material part 200, but may be provided only on some of the side surfaces 210′. For example, as shown in FIG. 11, the seating groove 300 may be provided only on the side surface 210′ that is rounded and has a curved shape among the plurality of side surfaces 210 formed by the material part 200.

The reason why the seating groove 300 is provided only on some of the side surfaces 210′ out of the side surfaces 210 formed by the material part 200 as above is to improve the productivity of the blank itself and to facilitate the process of mounting the guard part 400 to the material part 200, and to prevent the guard part 400 mounted on the material part 200 from moving along the circumferential direction of the material part 200.

That is, the guard part 400 mounted on the on the side surface 210′ that has a curved shape among the plurality of side surfaces 210 formed by the material part 200 may be prevented from moving in the circumferential direction of the material part 200 by having the side thereof blocked by the side surface 210 of the material part 200 on which the seating groove 300 is not provided.

As a result, the guard part 400 is firmly mounted on the side surface 210′ of the material part 200, so that the guard part 400 does not separate from or move from the material part 200 by the pressing force of the jigs J1 and J2.

Although specific embodiments according to the present disclosure have been described so far, various modifications are possible without departing from the scope of the present disclosure.

Therefore, the scope of the present disclosure should not be limited to the described embodiments, but should be determined by the scope of the claims described below as well as their equivalents.

### INDUSTRIAL APPLICABILITY

The present disclosure be applied and sold in the medical industry.

1. A blank for manufacturing dental prostheses, the blank comprising:
a material part configured to provide a predetermined processing area that is in direct contact with a machining tool of a machining apparatus, and to form a plurality of side surfaces;
a seating groove provided on the plurality of side surfaces of the material part; and
a guard part mounted on the plurality of side surfaces of the material part by using the seating groove, and configured to come into direct contact with a circular frame-shaped jig of the machining apparatus.

2. The blank of claim 1, wherein the seating groove is provided on all of the side surfaces formed by the material part, or is provided on some of the side surfaces formed by the material part.

3. The blank of claim 2, wherein the guard part is provided in plural numbers on the material part at predetermined intervals along a circumferential direction of the material part.

4. The blank of claim 3, wherein a separation space is created between the side surface of the material part and the jig.

5. The blank of claim 3, wherein the guard part comprises:
an inner member inserted into the seating groove with a shape corresponding to an inner space created by the seating groove; and
an outer member integrally connected to the inner member and disposed to protrude outward from the side surface of the material part so as to make surface contact with the jig of the machining apparatus.

6. The blank of claim 5, wherein the seating groove, the side surface of the material part where the seating groove is provided and the guard part is mounted, and the guard part have a curvature corresponding to a curvature of the circular frame-shaped jig.

7. The blank of claim 5, wherein the outer member comprises:
a first contact surface configured to extend upward or downward from a side of the inner member and to come in surface contact with the side surface of the material part; and
a second contact surface configured to extend horizontally from a top or bottom of the first contact surface and to come in surface contact with a bottom or top surface of the circular frame-shaped jig.

8. The blank of claim 6, wherein the guard part has a thickness smaller than a thickness of the material part.

9. The blank of claim 8, wherein when the circular frame-shaped jig is placed on the second contact surface, an inner peripheral surface of the jig comes in surface contact with the side surface of the material part that is not in contact with the first contact surface.
